(19) United States
(12) Patent Application Publication
(10) Pub. No.: US 2005/0083021 A1
(43) Pub. Date: Apr. 21, 2005

(54) Energy storage device

(76) Inventor: Peter John Mahon, Narrabundam (AU)

Correspondence Address: KENYON & KENYON, 1500 K STREET, N.W., SUITE 700, WASHINGTON, DC, 20005, US

(21) Appl. No.: 10/747,980

(22) Filed: Dec. 31, 2003

Related U.S. Application Data
(63) Continuation of application No. 10/019,237, filed on May 13, 2002, now abandoned.

(30) Foreign Application Priority Data
Jul. 12, 1999 (AU) PQ 1578
Jul. 13, 1999 (AU) PQ 1602

(51) Int. Cl. H02J 1/00

(52) U.S. Cl. 320/166

(57) ABSTRACT

An energy storage device includes a cylindrical shrink wrap housing having two opposed metal terminals. An electrochemical device in the form of a dry cell alkaline battery is disposed within the housing for providing an electrical potential between the terminals. An electric double layer supercapacitor is wrapped around and mounted to the housing and connected to the terminals in parallel with the battery.

The present invention relates to an energy storage device.

The invention has been developed primarily for providing an energy store for portable electrical devices such as mobile telephones and laptop computers and will be described hereinafter with reference to that application. However, the invention is not limited to that particular field of use and is also applicable to other electrical loads including those that are remote from mains supplies or those that have high peak currents and low average currents.

### BACKGROUND OF THE INVENTION

Dry cell and alkaline batteries, both in primary and sec ry form, are used in a wide variety of applications. Primary batteries are once only or disposable batteries, while secondary batteries are rechargeable. Batteries of these kinds are used in mobile and cellular telephones, portable computers, cordless electric power tools, household appliances, cameras, and other mobile devices to name but a few. These form of batteries are preferred as they provide a relatively high energy density and are relatively inexpensive. The latter is of particular importance for primary cells which are, in effect, consumables.

Batteries are either primary and secondary sources and can be either wet or dry cell. Some of the commonly available types are alkaline, Lithium ion, Lithium polymer, Nickel Metal Hydride, Nickel Cadmium or Carbon Zinc. Of the primary batteries, the most common batteries are in the form of cylindrical cells, each of which provides a potential of about 1.5 Volts. A number of such cells are generally connected in series to provide the necessary voltage for the device concerned. These cells are specified by size categorisations, which are designated, for example, as N, AAAA, AAA, AA, C and D. Other prismatic forms are also available.

These batteries suffer firm several limitations including poor accommodation of wide variations in load currents and a low efficiency at high load currents. Accordingly, in circumstances where a constant load current is drawn, such as in torch, a bate is an ideal source of energy. However, where varying load cod and particularly high load currents for high power applications are encountered, the battery life becomes compromised. For example, when a power tool such as an electric drill, is operating at a constant low current to provide a given torque, the battery is efficiently providing the necessary energy requirements. However, should the operator require a higher torque for a short period, a pulse or surge of power will be required. Although this demand for transitory power is common in many electrical appliances and devices, it is not efficiently provided by a battery. There are a number of strategies that are adopted to overcome this inherent compromise. For the example of the electric drill, it is known to make use of adjustable gearing to provide a wider range of available torque.

Similar problems to that foreshadowed above for the drill arise for other devices whether they are toys, electronic games, mobile or cellular phones, portable or laptop computers or the like. In an attempt to address this limitation it has been known to provide a battery having a slightly lower internal resistance. However, this form of battery design comprises the energy density of the resultant battery.

### SUMMARY OF THE INVENTION

It is an object of the present invention to over ome or ameliorate at least one of the disadvantages of the prior art, or to provide a useful alternative.

According to a fist aspect of the invention there is provided an energy storage device including:
a housing having two terminals;
an electrochemical device disposed within the housing for providing an electrical potential between the terminals; and
a first capacitor mounted to the housing and being electrically connected to the terminals in parallel with the electrochemical device.

Preferably, the capacitor extends about the housing. More preferably, the housing is cylindrical and extends between two opposed axially spaced apart ends, whereby the ends define respective terminals and the capacitor extends about the housing intermediate the ends.

Preferably also, the capacitor is an electric double layer supercapacitor including:
a capacitor housing;
a first and a second opposed sheet electrodes disposed within the housing and being respectively electrically connected to the terminals;
a separator located between the electrodes; and
an electrolyte intermediate the electrodes for allowing charge to be stored at the electrodes.

In a preferred form, the capacitor is flexible and wrapped about the housing. However, in other embodiments, the capacitor is flexible and configured as a tube that is disposed within the housing. Preferably, in either case, the capacitor is wrapped around the electrochemical device.

Preferably, the electrochemical device is generally cylindrical and extras between two opposed axially spaced apart ends and the first capacitor extends axially away from one of the ends. More preferably, the energy storage device includes a second capacitor which has an aperture for receiving the electrochemical device.

In a preferred form, the aperture receives both the electrochemical device and the first capacitor. More preferably, the second capacitor is tubular and extends about the first capacitor and the electrochemical device.

Preferably, the electrochemical device is a battery and the capacitor is an electric double layer supercapacitor. More preferably, the battery is a Li-Ion battery that has a solid electrolyte. Even more preferably, the electrolyte includes a polymer.

Preferably also, the electrochemical device and the capacitor each include a pair of electrodes that are electrically connected to the respective terminals. More preferably, the electrodes are fixedly connected to the respective terminals. However, in some embodiments, at least one of the electrodes of the capacitor are selectively electrically isolated from the terminals. In the case of the latter, it is preferred that the energy storage device includes a switch that is electrically disposed between one of the terminals and one of the electrodes of the capacitor for effecting the selective electrical isolation.

The electrochemical device and the capacitor each include a power density and an energy density. Preferably, the energy deity of the electrochemical device is greater than the energy density of the capacitor and the power deity of the electrochemical device is less than the power density of the capacitor.

According to a second aspect of the invention there is provided an energy storage device including:
a housing having two terminals; and
a first capacitor forming part of the housing and connected to the terminals.

Preferably, the housing has a form factor corresponding or being related to battery size designations N, AAAA, AAA, AA, C or D.

More preferably, an electrochemical device is disposed with the housing for providing electrical energy to the terminals. More preferably, the electrochemical device extends about the housing.

Preferably also, the housing is cylindrical and extends between two opposed axially spaced apart ends, whereby the ends define respective terminal and the capacitor extends about the housing intermediate the ends.

Preferably, the capacitor is an electric double layer supercapacitor including:
a capacitor housing;
a first and a second opposed sheet electrodes disposed within the housing and being respectively electrically connected to the terminal a separator located between the electrodes; and
an electrolyte intermediate the electrodes for allowing charge to be stored at the electrodes.

In a preferred form, the capacitor is flexible and wrapped about the housing. However, in other embodiments, the capacitor is flexible and configured as a tube that is disposed within the housing. Preferably, in either case, the capacitor is wrapped around the electrochemical device.

Preferably also, the electrochemical device is generally cylindrical and extends between two opposed axially spaced apart ends and the first capacitor extends axially away from one of the ends. More preferably, the energy storage device is of hollow construction with an aperture for receiving the electrochemical device. Even more preferably, the aperture receives both the electrochemical device and a second capacitor.

In a preferred form, the first capacitor is tubular and extends about the second capacitor and the electrochemical device.

According to another aspect of the invention there is provided an energy storage device including:
a housing having an interior and an exterior where the interior defines a cavity, two terminals disposed on or adjacent to the exterior of the housing for electrically engaging with respective terminals of a load that requires a predetermined load current;
an electrochemical device disposed within the cavity and being electrically connected to the terminals for providing a first current to the load; and
a capacitor disposed within the cavity and being electrically connected to the terminals in parallel with the electrochemical device for providing a second cum nt to the load, whereby the fast current and the second currents collectively sum to the predetermined load current.

Preferably, the electrochemical device includes an anode and a cathode that are respectively fixedly electrically connected to the terminals by way of an anode tab and a cathode tab, and the capacitor includes a positive electrode and a negative electrode that are respectively fixedly electrically connected to the terminals by way of a positive electrode tab and a negative electrode tab. More preferably, the terminals extend from the interior to the exterior and the anode tab, the cathode tab, the positive electrode tab, and the negative electrode tab are disposed entirely within the cavity.

In a preferred form, the capacitor is an electric double layer supercapacitor including:
a capacitor housing;
a first and a second opposed sheet electrodes disposed within the housing and being respectively electrically connected to the terminals;
a separator located between the electrodes; and
an electrolyte intermediate the electrodes for allowing charge to be stored at the electrodes.

Preferably, the housing is flexible. More preferably, the energy storage device is flexible. In other embodiments, however, the housing and the electrochemical device are rigid and the capacitor is flexible and packed about the electrochemical device.

### BRIEF DESCRIPTION OF THE DRAWINGS

Preferred embodiments of the invention will now be described by way of example only, with reference to the accompanying drawings in which.

FIG. 1 is a schematic perspective view of an energy storage device according to the invention;

FIG. 2 is a cross section taken along line 2-2 of FIG. 1;

FIG. 3 is a schematic plan view of the supercapacitor used in the device of FIG. 1, where the supercapacitor is shown in the unwound configuration;

FIG. 4 illustrates the supercapacitor of FIG. 3 in a wound configuration prior to mounting to the housing;

FIG. 5 is a chart illustrating the discharge profile for a prior art battery and an energy storage device according to the present invention;

FIG. 6 is a schematic sectional view of another device according to the invention;

FIG. 7 is a schematic plan view of an alternative supercapacitor;

FIG. 8 is a plan view of another energy storage device according to the invention that is for use with a GSM telephone and which includes the supercapacitor of FIG. 7; and

FIG. 9 is a schematic cross sectional view taken along line 9-9 of FIG. 8.

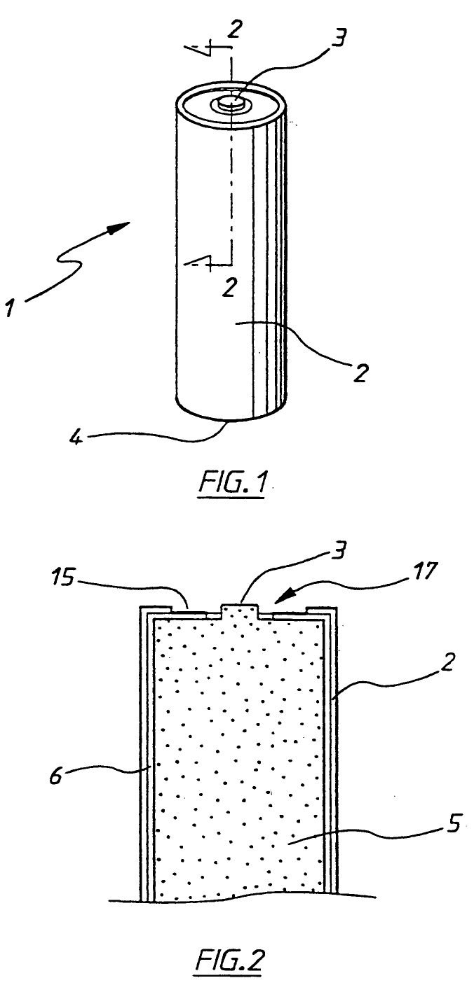

Referring to the drawings, and in particular to FIG. 1 and FIG. 2, there is illumed an energy storage device 1. The device includes a cylindrical shrink wrap housing 2 having two opposed metal terminals 3 and 4. An electrochemical device in the form of a dry cell alkaline battery 5 is disposed within housing 2 for providing an electrical potential between the terminals. An electric double layer supercapacitor 6 is wrapped around and mounted to housing 2 and connected to terminals 3 and 4 in parallel with battery 5.

### DETAILED DESCRIPTION OF THE INVENTION

As shown in FIG. 3, supercapacitor 6 is formed from two like opposed rectangular aluminium sheet electrodes 10 which are maintained in a spaced apart overlying configuration by an intermediate separator 11. Each electrode includes a coating of activated carbon for providing a high surface area. Moreover, each electrode includes a protruding tab, which are separately numbered 15 and 16. The tabs includes respective central apertures 17 and are configured such that they protrude from opposite edges of the respective sheets.

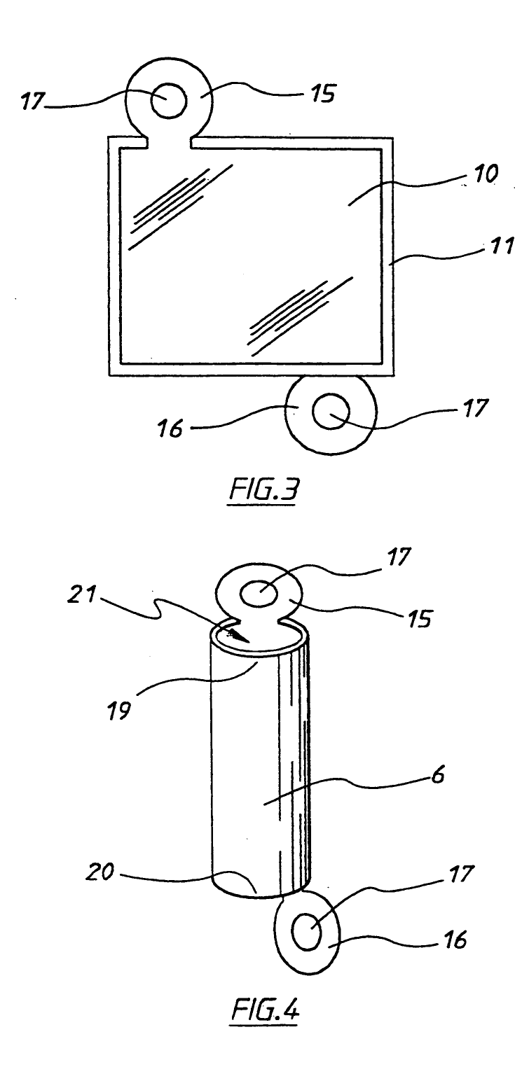

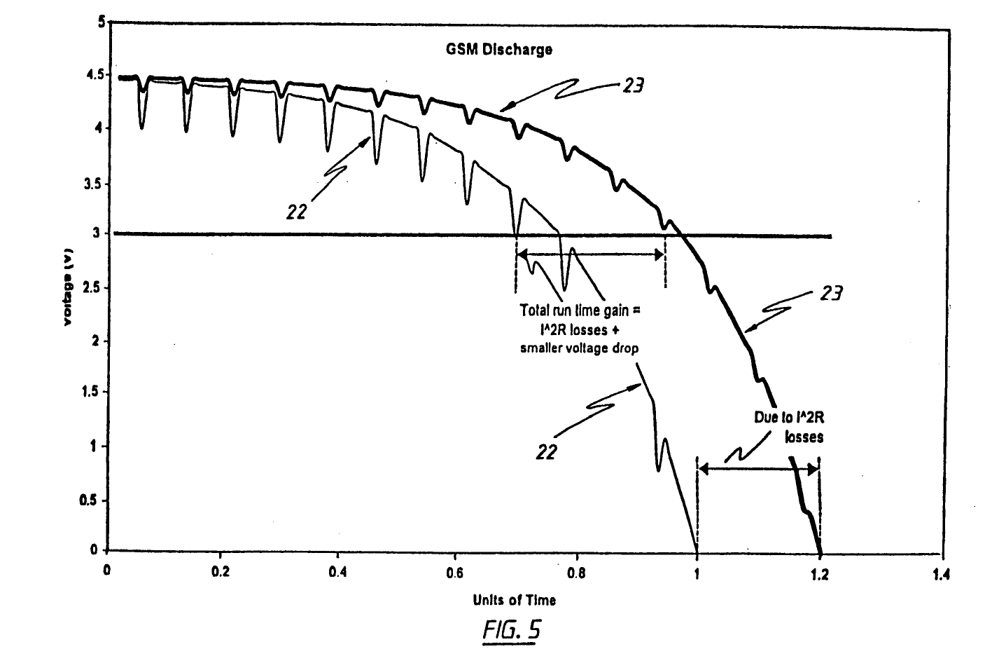

The elements shown in FIG. 3 are placed in a package with only tabs 15 and 16 protruding. An electrolyte is placed in the package before it is sealed. This arrangement is then wound to provide the tubular supercapacitor 6, as best shown in FIG. 4. The supercapacitor is hollow and extends axially between a first end 19 and a second opposed end 20. Each of the ends includes an apt 21.

The internal diameter of the supercapacitor is such as to complementarily receive battery 5, which is inserted through one of apertures 21. Moreover, ends 19 and 21 are axially spaced apart to be co-terminus with the adjacent ends of the battery. That is, supercapacitor 6 provides a sheath into which battery 5 is received. Once so received, tabs 17 and 18 are folded across respective adjacent apertures 21 and welded, soldered or otherwise electrically connected to the battery terminals such that battery 5 and supercapacitor 6 are connected in parallel. In this embodiment use is made of ultrasonic welding. It will be appreciated the positive terminal of battery 5 includes a detent which is received by and which extends through aperture 17.

Thereafter shrink wrap 2 is applied and device 1 is ready for use. It will be appreciated that device 1, when wound, has a total wall thickness of about 0.2 mm. That is, device 1 only increases the diameter of the battery about which it is disposed by about 0.4 mm.

Supercapacitor 6 provides a capacitance of about 0.5 Farads and an esr of 10 milliohms. Accordingly, device 1 offers performance characteristics which are far superior to that of boy 5 alone. That is, in situations where pulse loading of device 1 occurs, a predominance of the energy provided will be from supercapacitor 5. This reduces the pulse load on battery 5 and, as such, allows the battery life to be extended. Moreover, between pulses battery 5 is able to recharge supercapacitor 6. That is, as the internal resistances of batteries are generally higher than the esr or equivalent series resistance of a capacitor or supercapacitor the use of such a capacitor or supercapacitor in parallel with the battery reduces the effective resistance of the resultant energy storage device.

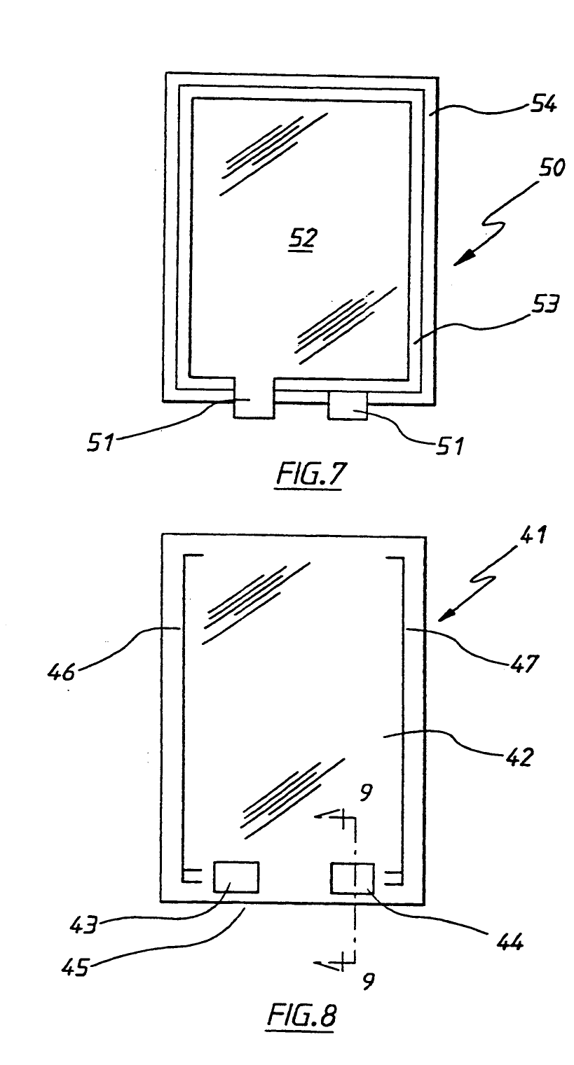

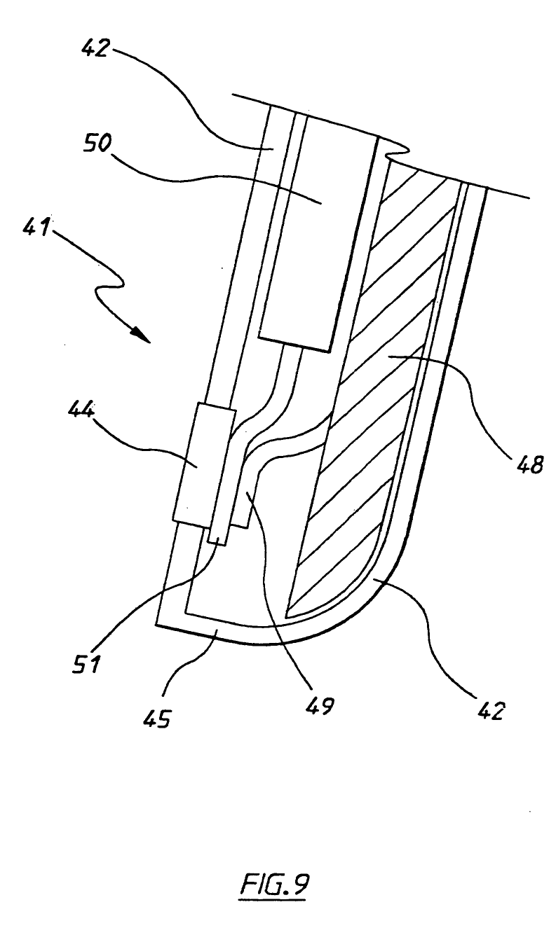

Another preferred embodiment of the invention is illustrated in FIGS. 7, 8 and 9. More particularly, with reference to FIG. 8, there is shown an orgy storage device 41 including a hard plastics housing 42. Device 41 has two rectangular metal terminals 43 and 44 which are adjacent one another and a bottom edge 45 of the housing. Device 41 is selectively engaged by way of formations 46 and 47 with a GSM telephone (not shown). Moreover, terminal 43 and 44 are located to abut corresponding terminals on the telephone to allow energy transfer to the telephone.

Device 41 includes an electrochemical device in the form of a Li-Ion battery 48 disposed within housing 42 for providing an electrical potential between the terminals. Battery 48 includes two electrode tabs 49 which electrically connect the respective positive and negative electrodes of the battery (not shown) to terminals 43 and 44.

A capacitor, in the form of a supercapacitor 50, is mounted internally to housing 42 and is electrically connected to terminals 43 and 44 in parallel with battery 48. That is, supercapacitor 50 includes two electrode tabs 51 that electrically connect the respective electrodes of the supercapacitor to terminals 43 and 44.

In the embodiment shown, tabs 51 are sandwiched between respective tabs 49 and teal 43 and 44. In some embodiments the actual physical connection between the tabs and the terminals is effected by welding or soldering. In this specific embodiment, however, the connection is effected by ultrasonic welding.

As best shown in FIG. 7, Supercapacitor 50 includes two electrodes 52 from which respectively extend tabs 51. The electrodes are generally rectangular and include respective carbon coatings that are opposed with each other. The electrodes are maintained in a fixed spaced apart configuration by a porous separator 53 that is non-conductive. The electrodes and the separator are contained within a sealed plastics laminar package 54 which contains an electrolyte for allowing ionic conduction between the electrodes. Tabs 51 extend from package 54 for connection with terminals 43 and 44, as discussed above.

In this embodiment, supercapacitor 50 is flexible to facilitate its incorporation into housing 42. This also allows supercapacitor 50 to be retro fitted into some existing housings. An example of the cons on of such a flexible supercapacitor is disclosed in a copending PCT patent application numbered PCT/AU99/00780, the disclosure of which is included herein by way of cross reference.

In some embodiments the housing is specifically configured to accommodate a rigid supercapacitor.

Battery 48 includes a solid polymer electrolyte (not shown) which, while providing good energy density, places a severe limitation on the peak current that can be provided by the battery if damage is to be avoided. The combination of battery 48 and supercapacitor 50, however, is selected so that, for the currents loads experienced, they do not suffer this same disadvantage. That is, the low esr of supercapacitor 50 ensures that peak current demand will be substantially supplied by the supercapacitor. That is, supercapacitor 50 is providing an averaging effect on the battery current. In this case the peak battery current will be closer to the average battery current than would be the case in the absence of the supercapacitor.

Based upon the above teaching, it becomes clear that the capacitance of supercapacitor 50 has to be sufficient to provide the energy required by the load in a typical cycle. This will also assist in limiting the peak current of the battery to much less than the peak current demanded by the load.

This embodiment of the invention is particularly advantageous as it makes use of a simple parallel connection and involves no intervening and expensive control circuitry. In some embodiments, however, use is made of a switch (not shown) for selectively electrically isolating at least one of the tabs 51 from the respective terminal of device 41. This switch cam be manually operated, although in other embodiments it is electrically operated by way of an IC.

As with many digital devices, the load that a GSM telephones pre to an energy supply device has a pulsed characteristic. This places a severe compromise on such a supply that utilises a battery as its only source. That is, the battery has to be designed to achieve a reasonable power density which, in turn, compromises energy density. The present invention, however, limits that compromise.

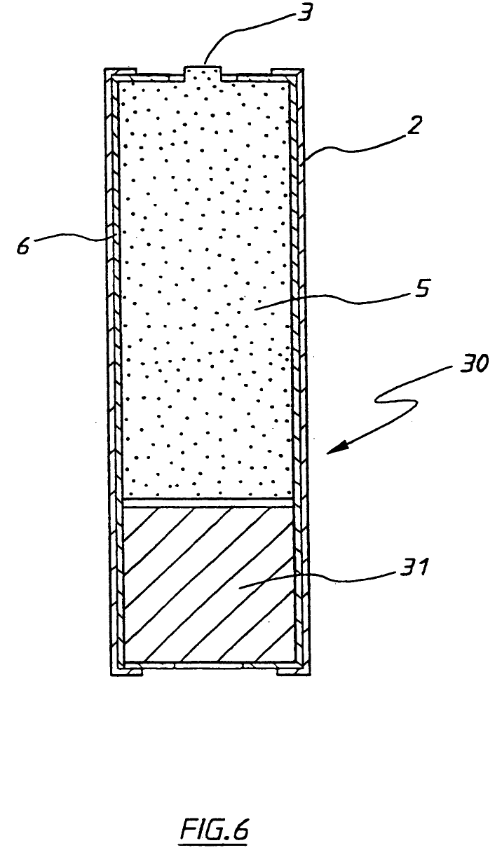

To better illustrate this, reference is made to FIG. 5. The first curve, labelled 22, shows the discharge characteristic of three serially connected prior art dry cell prey batteries under a pulse load such as that provided by a GSM mobile telephone. The voltage provided by the batteries is dependent not only upon the remaining energy stored but also on the size and duration of the pulsed load. In addition, the internal resistance of a battery generally increases with decreasing energy stored. Thus there is a threefold effect. Firstly as a result of high power pulses the battery looses energy or capacity due to I²R energy losses. Secondly, as the energy stored in the battery becomes depleted, the I²R energy losses increase. Thirdly, the voltage provided at the battery terminals decreases due to the IR drop as a result of the increased internal resistance of the battery, the increasing IR drop with increasing resistance, and the decreasing energy stored.

In the chart of FIG. 5, the minimum operating voltage for the particular application is 3 Volts. In so far as the prior art device is concerned this minimum is reached quickly due to the three fold effect mentioned above.

An embodiment of the invention utilising series connected batteries of the same capacity, in parallel combination with respective series connected supercapacitors 6, provides the characteristic illustrated with curve 23. That is, the operational life of this embodiment is greater than that of the prior art as the I²R losses, the voltage drop at the terminals of the device and the increase in battery internal resistance are less. This is a direct result of supercapacitor 6 working in parallel with battery 5 to supply most of the energy required by the individual pulses at the time of the pulse. This, in turn, occurs due to the lower esr and large capacitance of supercapacitor 6 and the quantum of the energy drawn with each pulse. Due to the lower esr of supercapacitor 6 the voltage drop across the energy storage device during the pulse is small and certainly less than that suffered by the prior art device illustrated in curve 22.

As the internal resistance of the battery is not now of such concern, the battery is configured for maximum energy density rather than maximum power density. The supercapacitor accommodates the power requirements of the load which allows the battery to be designed for maximum energy density. This combination also provides an extended life for the preferred embodiments in comparison to corresponding prior art devices.

In another embodiment, illustrated in FIG. 6 where corresponding features are denoted by corresponding reference numerals, a device 30 includes an electrolytic capacitor 31. This additional capacitor extends axially away from one end of battery 5 and is sheathed within supercapacitor 6. Capacitor 31 is connected in parallel with both battery 5 and supercapacitor 6. While capacitor 31 has a much smaller capacitance and similar or smaller esr to supercapacitor 6, it allows device 30 to accommodate extremely high frequency pulses without compromising the life of the battery.

Preferably, the external dimensions of device 30 correspond with the external dimensions of a prior art battery. For example, in one embodiment, device 30 has external dimensions of a AA battery, although the 5 utilised within the device is an AAA cell.

In other embodiments, supercapacitor 6 is disposed wholly within the existing housing of the battery. In other embodiments, battery 5 and capacitor 31 are utilised without supercapacitor 6.

Although the supercapacitor and battery are shown as a single unit, they are, in some cases, separately obtained and combined by the user. Particularly in the FIG. 1 embodiment, the supercapacitor can be retro fitted to an existing battery, whether or not that is a primary or a secondary cell.

The embodiments of the invention are particularly advantageously applied to pulsed load applications. Preferably, the esr and capacitance of the capacitor or supercapacitor used in parallel with the battery are selected based upon the characteristics of the load. Accordingly, while general purpose devices are also constructed, the invention allows economical tailoring of energy storage devices to load specific applications.

The use of a supercapacitor that is flexible has a number of advantages. For example, in some embodiments, the supercapacitor is combined in an existing housing with an existing rigid electrochemical cell. That is, the flexible nature of the supercapacitor allows it to be folded and/or wrapped about the electrochemical cell and to fill any available space in the housing rather than having to have a purpose specific space made available for it. Accordingly, cost and capital savings can be realised. In other embodiments, however, specific packaging is produced.

Another example of the benefits of the flexible packaging is obtained in those embodiments which also utilise flexible battery packaging, such as has been achieved with Li-Ion babies that have solid polymer electrolytes. That is, the flexible packaging for the two different energy storage components can be selected to be similar, and in some cases, the sane. Moreover, the common problem of electrolyte contamination is minimised as only one pair of terminals emerges from the package rather than two separate pairs as would be the case with separate packages. That is, the point of ingress of contaminants is greatest about the point of bonding between the terminals and the packaging.

The preferred embodiments of the invention that have been described above offer respective unitary energy storage devices that combines at least two different device types. These combinations provide:
Improved energy supply characteristics, particularly to pulsed loads;
Improved nm-times for the electrical device, which is of considerable significance to portable devices such as mobile telephones and laptop computers;
Peak current limiting for the battery—which extends battery lifetime and prevents damage to the battery
A single package for two separate types of storage devices, which adds considerable convenience to users of portable devices; and
A combination of storage devices that will compatibly interact during both charge and discharge cycles.

Although the invention has been descried with reference to specific eagles it will be appreciated by those skilled in the art that it may be embodied in many other forms.

1-53. (canceled)

54. An energy storage device including:
a housing having two terminals;
an electrochemical device disposed within the housing for providing an electrical potential between the terminals, wherein the electrochemical device has one or more performance parameters that changes with time; and
a first supercapacitor mounted to the housing and being electrically connected to the terminals in parallel with the electrochemical device for compensating for changes in the one or more performance parameters.

55. An energy storage device according to claim 54 wherein the supercapacitor substantially compensates for the one or more changes in the performance parameters.

56. An energy storage device according to claim 54 wherein the performance parameter is the series impedance of the electrochemical device.

57. An energy storage device according to claim 54 wherein the electrochemical device has an impedance that reduces the potential as current is drawn from the electrochemical device, and the performance parameter corresponds to the reduction in the potential.

58. An energy storage device according to claim 57 wherein the change in the potential is less than a predetermined value.

59. An energy storage device according to claim 54 wherein the performance parameter is the power density of the electrochemical device.

60. An energy storage device according to claim 59 wherein the power density has a predetermined minimum.

61. An energy storage device according to claim 59 wherein the power density is volumetric.

62. An energy storage device according to claim 59 wherein the power density is gravimetric.

63. An energy storage device according to claim 54 wherein the performance parameter is the energy stored in the electrochemical device.

64. An energy storage device according to claim 63 wherein the energy stored has a predetermined minimum.
